(19) United States
(12) Patent Application Publication
(10) Pub. No.: US 2019/0063588 A1
(43) Pub. Date: Feb. 28, 2019

(54) Control Methods During Over Temperature Operation Of A Ball-Type Continuously Variable Transmission

(71) Applicant: Dana Limited, Maumee, OH (US)

(72) Inventors: Jeffrey M. David, Leander, TX (US); T. Neil McLemore, Leander, TX (US); Travis J. Miller, Leander, TX (US)

(21) Appl. No.: 16/115,993

(22) Filed: Aug. 29, 2018

Related U.S. Application Data
(60) Provisional application No. 62/552,111, filed on Aug. 30, 2017.

(51) Int. Cl. F16H 57/04; F16H 15/50

(52) U.S. Cl. CPC F16H 57/0447; F16H 57/0412; F16H 57/048; F16H 15/503; F16H 57/0434

(57) ABSTRACT

Provided herein a vehicle including an engine, a first motor/generator, a second motor/generator, a ball-type planetary variator (CVP) and a controller configured to detect an over-temperature mode of operation, wherein the controller commands a change in a lube flow to the CVP based on the over-temperature mode.

### RELATED APPLICATION

This application claims priority to US Provisional Application No. 62/552,111 filed on Aug. 30, 2017, which is hereby incorporated herein by reference in its entireties.

### BACKGROUND

Continuously variable transmissions (CVT) and transmissions that are substantially continuously variable are increasingly gaining acceptance in various applications. The process of controlling the ratio provided by the CVT is complicated by the continuously variable or minute gradations in ratio presented by the CVT. Furthermore, the range of ratios that are available to be implemented in a CVT are not sufficient for some applications. A transmission is capable of implementing a combination of a CVT with one or more additional CVT stages, one or more fixed ratio range splitters, or some combination thereof in order to extend the range of available ratios. The combination of a CVT with one or more additional stages further complicates the ratio control process, as the transmission will have multiple configurations that achieve the same final drive ratio. Often, the CVT is operably coupled to a torque converter device, therefore coordinated control of both the CVT and the torque converter to manage fluid temperature is needed.

### SUMMARY

Provided herein is a vehicle including: an engine; a first motor/generator; a second motor/generator; a ball-type planetary variator (CVP); and a controller configured to detect an over-temperature mode of operation, wherein the controller commands a change in a lube flow to the CVP based on the over-temperature mode.

In some embodiments, the controller commands a change in an engine torque based on the over-temperature mode.

In some embodiments, the controller detects the over-temperature mode of operation based on an oil temperature of the CVP.

In some embodiments, the controller is configured to execute a passive over-temperature control process and an active over-temperature control process based on the oil temperature of the CVP.

Provided herein is a method for controlling an electric hybrid vehicle having an engine, a first motor/generator, a second motor/generator, and a ball-type planetary variator (CVP), the method including the steps of: receiving a plurality of signals provided by sensors located on the vehicle, the plurality of signals including: a CVP ratio, a CVP oil temperature, an engine speed, an engine torque, a torque converter turbine speed, a motor/generator speed, and a motor/generator torque; detecting an over-temperature condition based on the CVP oil temperature; determining an engine torque command; and commanding the engine to operate at the engine torque command.

In some embodiments, determining an engine torque command further includes evaluating a total heat generation based on the CVP ratio, the engine speed, the torque converter turbine speed, and the engine torque.

In some embodiments, determining an engine torque command further includes evaluating a total heat generation based on the motor/generator speed and the motor/generator torque.

In some embodiments, determining an engine torque command further includes evaluating a tractive effort requirement for the vehicle.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the devices are utilized, and the accompanying drawings of which:

FIG. 1 is a side sectional view of a ball-type variator.

FIG. 2 is a plan view of a carrier member that used in the variator of FIG. 1.

FIG. 3 is an illustrative view of different tilt positions of the ball-type variator of FIG. 1.

FIG. 4 is a block diagram schematic of a vehicle control system that could be implemented in a vehicle.

FIG. 5 is a flow chart depicting an enable process for entering and exiting an over-temperature operating mode that is implementable in the vehicle control system of FIG. 4.

FIG. 6 is a flow chart depicting a passive over-temperature control process that is implementable in the vehicle control system of FIG. 4.

FIG. 7 is a flow chart depicting an active over-temperature control process that is implementable in the vehicle control system of FIG. 4.

FIG. 8 is a block diagram depicting a solution set evaluation process that is implementable in the active over-temperature control process of FIG. 7.

### DETAILED DESCRIPTION OF THE PREFERRED EMBODIMENTS

An electronic controller is described herein that enables electronic control over a variable ratio transmission having a continuously variable ratio portion, such as a Continuously Variable Transmission (CVT), Infinitely Variable Transmission (IVT), or variator. The electronic controller can be configured to receive input signals indicative of parameters associated with an engine coupled to the transmission. The parameters can include, but are not limited to, throttle position sensor values, accelerator pedal position sensor values, vehicle speed, gear selector position, user-selectable mode configurations, and the like, or some combination thereof. The electronic controller can also receive one or more control inputs. The electronic controller candetermine an active range and an active variator mode based on the input signals and control inputs. The electronic controller can control a final drive ratio of the variable ratio transmission by controlling one or more electronic actuators and/or solenoids that control the ratios of one or more portions of the variable ratio transmission.

The electronic controller described herein is described in the context of a continuous variable transmission, such as the continuous variable transmission of the type described in U.S. patent application Ser. No. 14/425,842, entitled “3-Mode Front Wheel Drive And Rear Wheel Drive Continuously Variable Planetary Transmission” and, U.S. patent application Ser. No. 15/572,288, entitled “Control Method of Synchronous Shifting of a Multi-Range Transmission Comprising a Continuously Variable Planetary Mechanism”, each assigned to the assignee of the present application and hereby incorporated by reference herein in its entirety. However, the electronic controller is not limited to controlling a particular type of transmission but rather, is optionally configured to control any of several types of variable ratio transmissions.

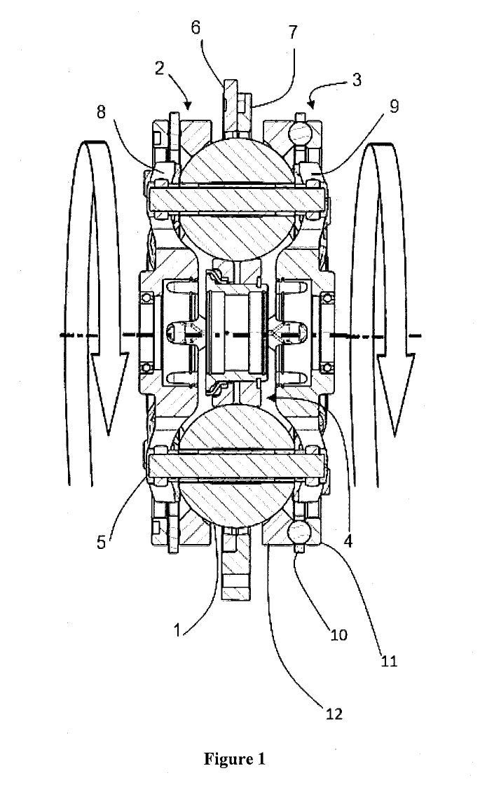

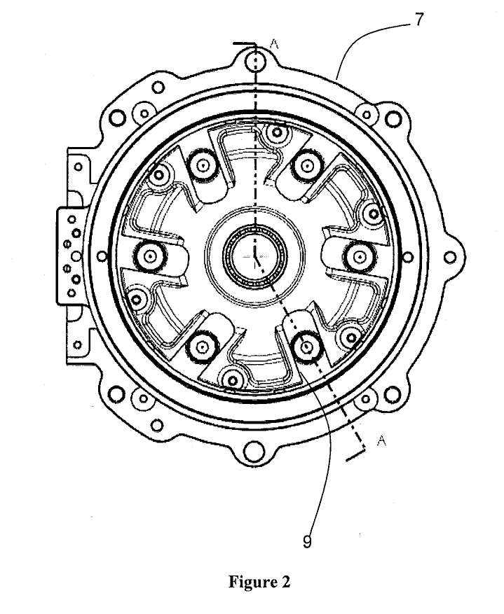

Provided herein are configurations of CVTs based on a ball-type variator, also known as CVP, for continuously variable planetary. Basic concepts of a ball-type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, as input (first) traction ring assembly 2 and output (second) traction ring assembly 3, and an idler (sun) assembly 4 as shown on FIG. 1. In some embodiments, the output traction ring assembly 3 includes an axial force generator mechanism. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjustable to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

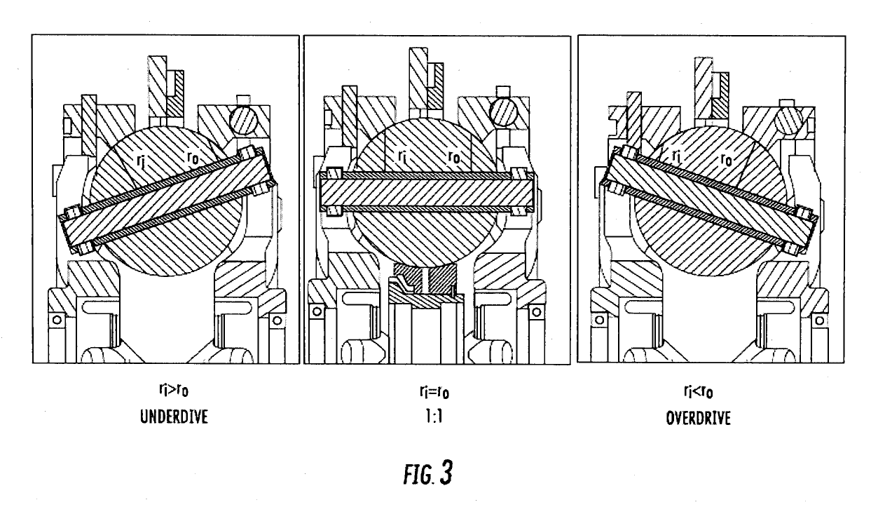

The working principle of such a CVP of FIG. 1 is shown on FIG. 3. The CVP itself works with a traction fluid. The lubricant (or traction fluid) between the ball and the conical rings acts as a solid at high pressure, transferring the power from the input ring, through the balls, to the output ring. By tilting the balls' axes, the ratio is changed between input and output. When the axis is horizontal, the ratio is one, as illustrated in FIG. 3, when the axis is tilted, the distance between the axis and the contact point change, modifying the overall ratio. All the balls' axes are tilted at the same time with a mechanism included in the carrier and/or idler. Embodiments disclosed herein are related to the control of a variator and/or a CVT using generally spherical planets each having a tiltable axis of rotation that is adjustable to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected”, “operationally coupled”, “operationally linked”, “operably connected”, “operably coupled”, “operably coupleable”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling will take a variety of forms, which in certain instances will be readily apparent to a person of ordinary skill in the relevant technology.

For description purposes, the term “radial”, as used herein indicates a direction or position that is perpendicular relative to a longitudinal axis of a transmission or variator. The term “axial” as used herein refers to a direction or position along an axis that is parallel to a main or longitudinal axis of a transmission or variator.

It should be noted that reference herein to “traction” does not exclude applications where the dominant or exclusive mode of power transfer is through “friction”. Without attempting to establish a categorical difference between traction and friction drives herein, generally, these are understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces that would be available at the interfaces of the contacting components and is a measure of the maximum available drive torque. Typically, friction drives generally relate to transferring power between two elements by frictional forces between the elements. For the purposes of this disclosure, it should be understood that the CVTs described here could operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”. Traction fluid is also influenced by entrainment speed of the fluid and temperature at the contact patch, for example, the traction coefficient is generally highest near zero speed and decays as a weak function of speed. The traction coefficient often improves with increasing temperature until a point at which the traction coefficient rapidly degrades.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer, is referred to as “creep in the rolling direction.” Sometimes the driving and driven elements experience creep in a direction orthogonal to the power transfer direction, in such a case this component of creep is referred to as “transverse creep.”

Those of skill will recognize that the various illustrative logical blocks, modules, circuits, and algorithm steps described in connection with the embodiments disclosed herein, including with reference to the transmission control system described herein, for example, could be implemented as electronic hardware, software stored on a computer readable medium and executable by a processor, or combinations of both. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans could implement the described functionality in varying ways for each particular application, but such implementation decisions should not be interpreted as causing a departure from the scope of the present embodiments. For example, various illustrative logical blocks, modules, and circuits described in connection with the embodiments disclosed herein could be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor could be a microprocessor, but in the alternative, the processor could be any conventional processor, controller, microcontroller, or state machine. A processor could also be implemented as a combination of computing devices, e.g., a combination of a DSP and a microprocessor, a plurality of microprocessors, one or more microprocessors in conjunction with a DSP core, or any other such configuration. Software associated with such modules could reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor reads information from, and write information to, the storage medium. In the alternative, the storage medium could be integral to the processor. The processor and the storage medium could reside in an ASIC. For example, in one embodiment, a controller for use of control of the CVT includes a processor (not shown).

Provided herein is a vehicle control system for controlling a vehicle an engine, a first motor/generator, a second motor/generator and a CVP. The vehicle control system includes the electronic controller as described above.

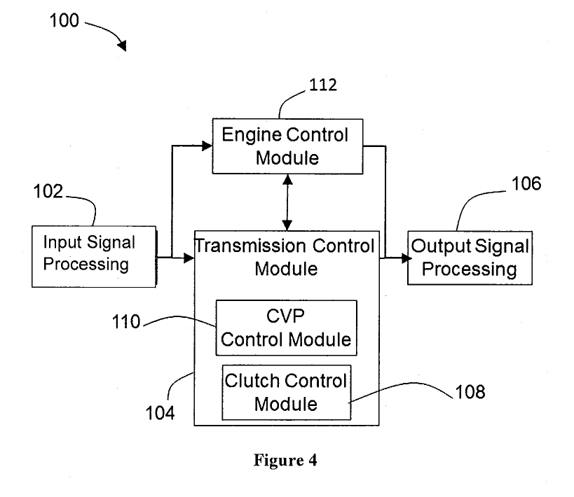

Referring now to FIG. 4, in some embodiments, a vehicle control system 100—includes an input signal processing module 102, a transmission control module 104 and an output signal processing module 106. The input signal processing module 102 is configured to receive a number of electronic signals from sensors provided on the vehicle and/or transmission. The sensors optionally include, but are not limited to, temperature sensors, speed sensors, position sensors, among others.

In some embodiments, the signal processing module 102 includes various sub-modules to perform routines such as signal acquisition, signal arbitration, or other known methods for signal processing.

In some embodiments, the output signal processing module 106 is configured to electronically communicate to a variety of actuators and sensors. In some embodiments, the output signal processing module 106 is configured to transmit commanded signals to actuators based on target values determined in the transmission control module 104.

In some embodiments, the transmission control module 104 includes a variety of sub-modules or sub-routines for controlling continuously variable transmissions of the type discussed here. For example, in some embodiments, the transmission control module 104 includes a clutch control sub-module 108 that is programmed to execute control over clutches or similar devices within the transmission.

In some embodiments, the clutch control sub-module 108 implements state machine control for the coordination of engagement of clutches or similar devices.

In some embodiments, the transmission control module 104 includes a CVP control sub-module 110 programmed to execute a variety of measurements and determine target operating conditions of the CVP, for example, of the ball-type continuously variable transmissions discussed here.

It should be noted that the CVP control sub-module 110 optionally incorporates a number of sub-modules for performing measurements and control of the CVP.

In some embodiments, the vehicle control system 100 includes an engine control module 112 configured to receive signals from the input signal processing module 102 and in communication with the output signal processing module 106. The engine control module 112 is configured to communicate with the transmission control module 104.

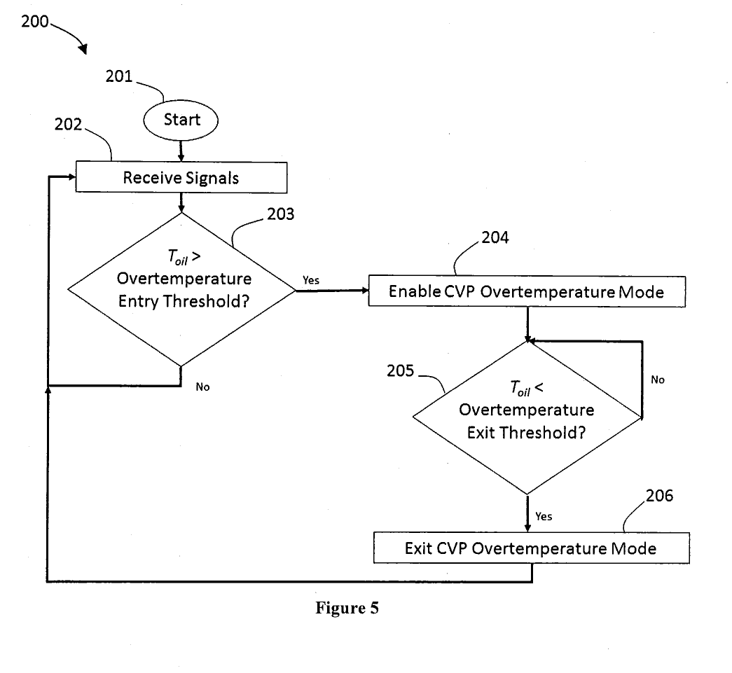

Referring now to FIG. 5, in some embodiments, an enable process 200 implementable in the vehicle control system 100 begins at a start state 201 and proceeds to a block 202 where a number of signals are received from other modules in the vehicle control system 100. The enable process 200 proceeds to a first evaluation block 203 where an oil temperature of a CVP, such as the CVP of FIGS. 1-3, is compared to an entry threshold temperature.

In some embodiments, the entry threshold temperature is a calibrateable variable stored in memory as a variable or a look-up table.

When the first evaluation block 203 returns a false result, indicating the oil temperature is below the entry threshold temperature, the enable process 200 returns to the block 202. When the first evaluation block 203 returns a true result, indicating that the oil temperature is above the entry threshold temperature, the enable process 200 proceeds to a block 204 where a command is sent to enable a CVP over-temperature mode of operation. The enable process 200 proceeds to a second evaluation block 205 where the oil temperature is compared to an exit threshold temperature.

In some embodiments, the exit threshold temperature is a calibrateable variable stored in memory as a variable or a look-up table.

When the second evaluation block 205 returns a false result, indicating that the oil temperature is above the exit threshold temperature, the enable process 200 continues to evaluate the exit threshold temperature. When the second evaluation block 205 returns a true result, indicating that the oil temperature is below the exit threshold temperature, the enable process 200 proceeds to a block 206 where a command is sent to exit the CVP over-temperature mode of operation. The enable process returns to the block 202.

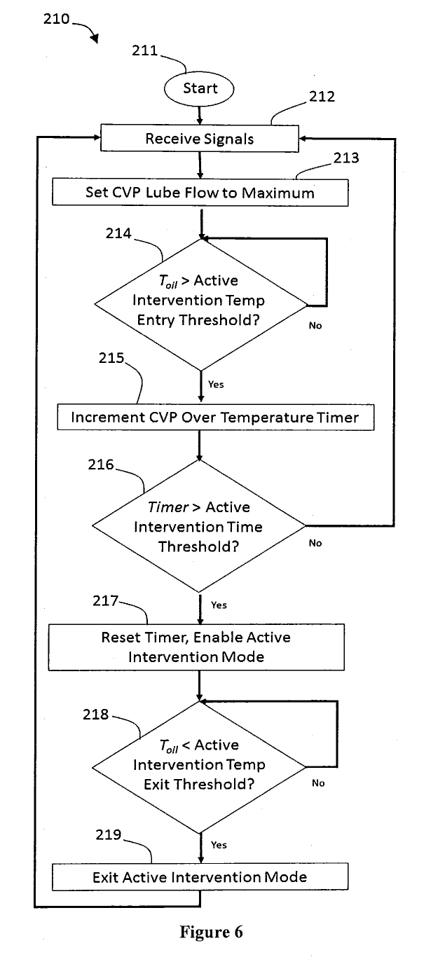

Referring to FIG. 6, in some embodiments, a passive over-temperature control process 210 is implementable in the vehicle control system 100. The passive over-temperature control process 210 begins at a start state 211 and proceeds to a block 212 where a number of signals are received from the vehicle control system 100. The passive over-temperature control process 210 proceeds to a block 213 where a command is sent to set a CVP lube flow to a maximum flow rate. The passive over-temperature process 210 proceeds to a first evaluation block 214 where a CVP oil temperature is compared to an active control temperature threshold.

In some embodiments, the active control temperature threshold is a calibrateable parameter stored in memory as a calibrateable variable or a look-up table.

When the first evaluation block 214 returns a false result, indicating that the CVP oil temperature is below the active control temperature threshold, the passive over-temperature control process 210 continues to evaluate the active control temperature threshold. When the first evaluation block 214 returns a true result, indicating that the CVP oil temperature is above the active control temperature threshold, the passive over-temperature control process 210 proceeds to a block 215 where a command is sent to increment a CVP over-temperature timer. The passive over-temperature control process 210 proceeds to a second evaluation block 216 where the CVP over-temperature timer is compared to an active time threshold.

In some embodiments, the active time threshold is a calibrateable parameter stored in memory as a calibrateable variable or a look-up table.

When the second evaluation block 216 returns a false result, indicating that the CVP over-temperature timer is below the active time threshold, the passive over-temperature control process 210 returns to the block 212. When the second evaluation block 216 returns a true result, indicating that the CVP over-temperature timer is above the active time threshold, the passive over-temperature control process 210 proceeds to a block 217 where a number of commands are sent to reset the CVP over-temperature timer and enable an active over-temperature control mode of operation. The pass over-temperature control process 210 proceeds to a third evaluation block 218 where the CVP oil temperature is compared to an active control exit temperature.

In some embodiments, the active control exit temperature is a calibrateable parameter stored in memory as a calibrateable variable or a look-up table.

When the third evaluation block 218 returns a false result, indicating that the CVP oil temperature is below the active control exit temperature, the passive over-temperature control process 210 continues to evaluate the active control exit temperature. When the third evaluation block 218 returns a true result, the passive over-temperature control process 210 proceeds to a block 219 where a command is sent to exit the active over-temperature control mode of operation. The passive over-temperature control process 210 returns to the block 212.

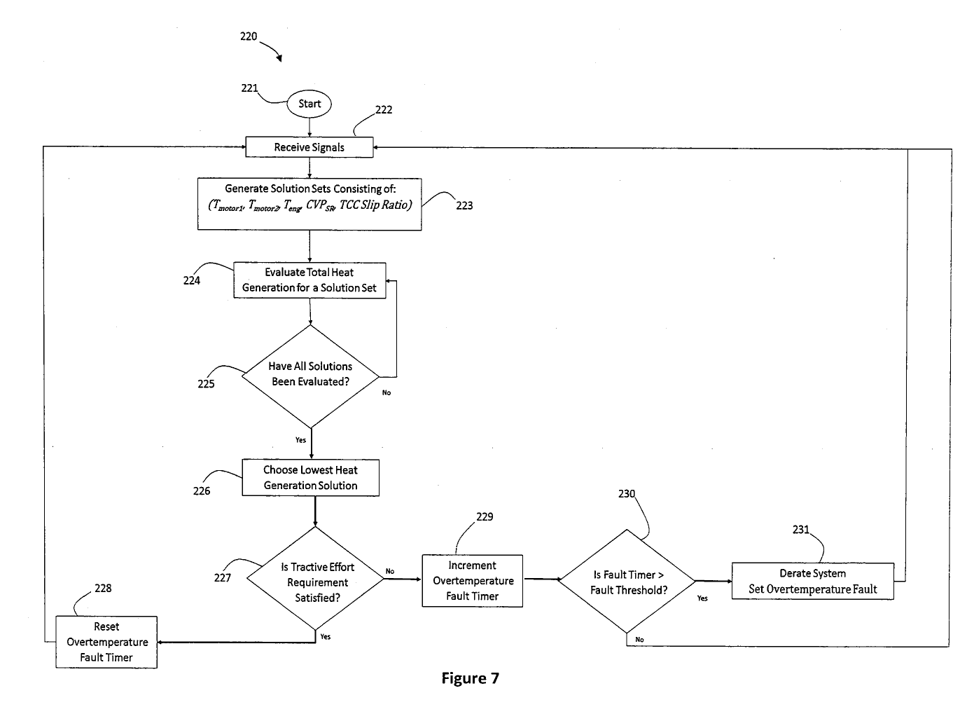

Referring now to FIG. 7, in some embodiments, an active over-temperature control process 220, implementable in the vehicle control system 100 begins at a start state 221 and proceeds to a block 222 where a number of signals are received from the vehicle control system 100. The active over-temperature control process 220 proceeds to a block 223 where a number of solution sets are generated that contain operating conditions for the CVP, torque converter, and engine.

In some embodiments, the solution sets include operating conditions for electric machines, such as motor/generators that are operably coupled to the engine and the CVP.

The active over-temperature control process 220 proceeds to a block 224 where a total heat generation for the solution sets formed in the block 223 is determined. The active over-temperature control process 220 proceeds to a first evaluation block 225. The first evaluation block 225 evaluates if all of the solution sets have been evaluated in the block 224. If the first evaluation block 225 returns a false result, the active over-temperature control process 220 returns to the block 224. If the first evaluation block 225 returns a true result, the active over-temperature control process 220 proceeds to a block 226 where a lowest heat generation solution is selected. The active over-temperature control process 220 proceeds to a second evaluation block 227 where a tractive effort requirement is evaluated. When the second evaluation block 227 returns a true result, indicating that the required tractive effort for the vehicle is satisfied by the operating conditions of the CVP, the engine, and the torque converter contained in the solution set selected in the block 226, the active over-temperature control process 220 proceeds to a block 228 where a command is sent to reset an over-temperature fault timer. The active over-temperature control process 220 returns to the block 222 from the block 228. When the second evaluation block 227 returns a false result, indicating that the required tractive effort for the vehicle is not satisfied by the operating conditions of the solution set selected in the block 226, the active over-temperature control process 220 proceeds to a block 229 where a command is sent to increment the over-temperature fault timer. The active over-temperature control process 220 proceeds to a third evaluation block 230 where the fault time is compared to a fault threshold.

In some embodiments, the fault threshold is a calibrateable parameter stored in memory as a variable or look-up table.

When the third evaluation block 230 returns a false result, indicating that the fault time is below the fault threshold, the active over-temperature control process 220 returns to the block 222. When the third evaluation block 230 returns a true result, indicating that the fault time is above the fault threshold, the active over-temperature control process 220 proceeds to a block 231 where a command is sent to derate the system and set an over-temperature fault status. In some embodiments, a command to derate the system corresponds to a reduction in engine torque. The active over-temperature process 220 returns to the block 222.

In some embodiments, the block 231 is configured to command the CVP to a ratio of 1:1. In other embodiments, the block 231 is configured to command the torque converter to lock and thereby reduce heat generation. In yet other embodiments, the block 231 is adapted to command alternative calibrations for the torque converter and the CVP.

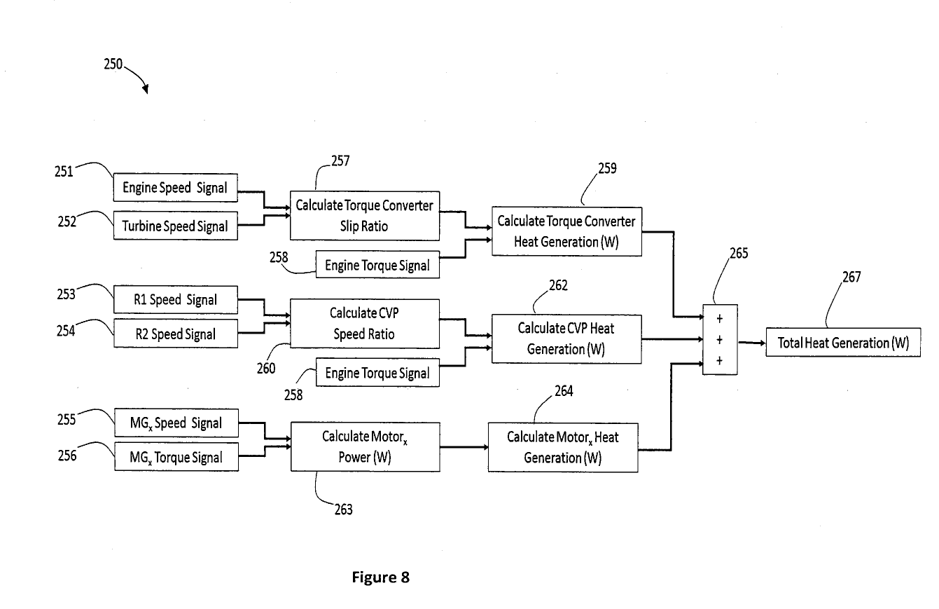

Turning now to FIG. 8, in some embodiments, a solution set evaluation process 250 is implementable in the block 224 of the active over-temperature control process 220. The solution set evaluation process 250 receives an engine speed signal 251, a torque converter turbine speed signal 252, a CVP first traction ring speed signal 253, a CVP second traction ring speed signal 254, a motor/generator speed signal 255, and a motor/generator torque signal 256.

In some embodiments, the solution set evaluation process 250 is provided with a first calculation process 257 that is adapted to calculate the torque converter slip ratio based on the engine speed signal 251 and the turbine speed signal 252.

The solution set evaluation process 250 receives an engine torque signal 258 from the vehicle control system 100. The solution set evaluation process 250 is provided with a second calculation process 259 configured to calculate the torque converter heat generation energy based on the engine torque signal 258 and the torque converter slip ratio determined in the first calculation block 257. The solution set evaluation process 250 includes a third calculation process 260 configured to calculate the CVP speed ratio based on the CVP first traction ring speed signal 253 and the CVP second traction ring speed signal 254. The solution set evaluation process 250 includes a fourth calculation process 262 adapted to calculate a CVP heat generation based on the engine torque signal 258 and the CVP speed ratio determined in the third calculation process 260. The solution set evaluation process 250 includes a fifth calculation process 263 configured to calculate a motor/generator power based on the motor/generator speed signal 255 and the motor/generator torque signal 256. The solution set evaluation process 250 includes a sixth calculation process 264 adapted to calculate a motor/generator heat generation based on the motor/generator power determined in the fifth calculation process 263. The results of the second calculation process 259, the fourth calculation process 262, and the sixth calculation process 262 are summed at a summation process 265 to form a total heat generation signal 267. During operation of the active over-temperature control process 220, the solution set evaluation process 250 is executed for each solution set formed in the block 223.

The foregoing description details certain embodiments. It will be appreciated, however, that no matter how detailed the foregoing appears in text, the preferred embodiments are practiced in many ways. As is also stated above, it should be noted that the use of particular terminology when describing certain features or aspects of the preferred embodiments should not be taken to imply that the terminology is being re-defined herein to be restricted to including any specific characteristics of the features or aspects of the preferred embodiments with which that terminology is associated.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the preferred embodiments described herein could be employed in practicing the preferred embodiments. It is intended that the following claims define the scope of the preferred embodiments and that methods and structures within the scope of these claims and their equivalents be covered thereby.

What is claimed is:

1. A vehicle comprising:
an engine;
a first motor/generator;
a second motor/generator;
a ball-type planetary variator (CVP); and
a controller configured to detect an over-temperature mode of operation,
wherein the controller commands a change in a lube flow to the CVP based on the over-temperature mode.

2. The vehicle of claim 1, wherein the controller commands a change in an engine torque based on the over-temperature mode.

3. The vehicle of claim 2, wherein the controller detects the over-temperature mode of operation based on an oil temperature of the CVP.

4. The vehicle of claim 3, wherein the controller is configured to execute a passive over-temperature control process and an active over-temperature control process based on the oil temperature of the CVP.

5. A method for controlling an electric hybrid vehicle having an engine, a first motor/generator, a second motor/generator, and a ball-type planetary variator (CVP), the method comprising the steps of:
receiving a plurality of signals provided by sensors located on the transmission, the plurality of signals comprising:
a CVP ratio,
a CVP oil temperature,
an engine speed,
an engine torque,
a torque converter turbine speed,
a motor/generator speed, and
a motor/generator torque;
detecting an over-temperature condition based on the CVP oil temperature;
determining an engine torque command; and
commanding the engine to operate at the engine torque command.

6. The method of claim 5, wherein determining an engine torque command further comprises evaluating a total heat generation based on the CVP ratio, the engine speed, the torque converter turbine speed, and the engine torque.

7. The method of claim 6, wherein determining an engine torque command further comprises evaluating a total heat generation based on the motor/generator speed and the motor/generator torque.

8. The method of claim 5, wherein determining an engine torque command further comprises evaluating a tractive effort requirement for the vehicle.
